(19) United States
(12) Patent Application Publication
(10) Pub. No.: US 2002/0133817 A1
(43) Pub. Date: Sep. 19, 2002

(54) Affinity marketing for interactive media systems

(76) Inventor: Steven O. Markel, Highlands Ranch, CO (US)

Correspondence Address: The Law Offices of William W. Cochran, LLC, Suite 230, 3555 Stanford Road, Fort Collins, CO, 80525, US

(21) Appl. No.: 10/099,054

(22) Filed: Mar. 13, 2002

Related U.S. Application Data
(60) Provisional application No. 60/275,295, filed on Mar. 13, 2001.

(51) Int. Cl. H04N 7/16; H04H 9/00

(52) U.S. Cl. 725/23; 725/13; 725/9

(57) ABSTRACT

Viewers of broadcast content are awarded points for responding to events contained in or presented during the broadcast. Points are accumulated and additional points may be awarded for viewing a plurality of episodes or presentations of an advertisement. Points may be redeemed for products or services. Broadcast content may be enhanced to include point event indicators. A software program, downloaded to a receiving unit, processes viewer responses and transfers response information to a server. Processing viewer responses may include a time period in which a viewer response is accepted. Reponses entered at other times, or responses greater than or equal to a predetermined number may be rejected. A website may provide viewer point information and awards information. A tool set allows simplified implementation of a points award program including specification of program name, broadcast content, schedule, events, point values, response time periods, data stored, schedule of storage and storage destination.

### CROSS REFERENCE TO RELATED APPLICATIONS

This application is based upon and claims the benefit of United States provisional application No. 60/275,295, entitled “AFFINITY MARKETING FOR INTERACTIVE TELEVISION”, filed Mar. 13, 2001 by Steven O. Markel, the entire disclosure of which is herein specifically incorporated by reference for all that it discloses and teaches.

### BACKGROUND OF THE INVENTION

a. Field of the Invention

The present invention pertains to television and broadcast media systems and more specifically to a system and method of increased viewership of programs and advertisements.

b. Description of the Background

Cable television, satellite, terrestrial broadcast, and Internet systems offer viewers a great expanse of program material. New channels and new programs, including educational, foreign, and local content, continue to emerge. With an ever-increasing range of content, broadcasters strive to attract viewers in order to generate advertising revenue. As such, the challenge to broadcasters is to attract an audience, maintain their viewing loyalty, and to provide a metric of viewership that may be employed to attract advertisers and to establish advertising rates.

In order to attract new viewers, broadcasters may introduce a new genre of programming such as ‘reality’ series comprising trivia contests with large monetary awards or survivalist contests, for example. If a new genre proves popular with a viewing audience, other broadcasters may duplicate the new genre, potentially reducing audience size for competing programs, or, over time the novelty of the new genre may erode, requiring new programming to attract viewers. Broadcasters may also employ methods to attract viewers to new program such as scheduling a new program between programs with an established audience. If a new program attains a significant audience, it may be moved to a new program time. Broadcasters may also air promotions for new programs in order to attract viewers. Such promotions may include snippets and ticklers to entice viewers to watch the programs.

Once a program has established an audience, the broadcaster strives to achieve viewer loyalty and maintain or increase the audience. Audience size and viewer loyalty affect the revenue a broadcaster may derive from advertisements shown in conjunction with the program. Ideally, viewer loyalty is attained through the quality and content of the program. Enhancing a program with additional information or interactive content may bolster viewer loyalty. A sporting event may be enhanced through additional information providing a player's biography or detailed scoring statistics, for example, that may be displayed to viewers with a set top box enabled television, interactive television, satellite receiver, computer, or similar system. Game show enhancements may provide information on the players, or allow the viewer to play along as a “virtual” contestant. This method has been successfully employed with a number of trivia game shows. A limitation of this method is that the viewer have a set top box equipped television or windowed display environment. As the base of set top boxes grow, especially with the deployment of digital broadcast, the issue of requiring a set top box for some forms of enhancement is attenuated. Enhancement may also employ the display of web-accessed information in synchrony with broadcast content. Enhancement information may be viewed, for example, on a laptop computer during a program, or may be displayed with the program on a single display unit. A method that has shown some success in attracting viewers is to provide a contest or sweepstakes during a program. Entry into the contest or sweepstakes may require that the viewer call a specified telephone number or mail a post card to a specified address. In a vast majority of cases, no feedback is provided to the viewer regarding receipt of an entry. Even if broadcasters employ various methods to attract viewers, viewers may mute the audio output or view another program when advertising is presented. Further, video recording equipment, such as some digital video recorders, for example, may allow deletion of advertising messages. A survey by one digital recorder manufacturer indicates that 84 percent of customers skip advertisements.

Broadcasters employ metrics of how many viewers watch each program in order to attract advertisers and to set advertising rates. An exact count of the number of viewers of a program is difficult to establish, in contrast to newspaper or magazine publications. An information service commonly employed is the Nielsen ratings from Nielsen Media Research, Inc headquartered at 299 Park Avenue New York, N.Y. 10171. Nielsen Media Research typically asks viewing habit questions to a small sample of approximately 5000 households. From this sampling, Nielsen generates a measure of how many people watched a particular program or advertisement.

The above methods of attracting and retaining viewers and providing a measure of audience size all have limitations, especially in gauging actual viewing of advertisements. Therefore a new method for attracting viewers and measuring audience size is needed.

### SUMMARY OF THE INVENTION

The present invention overcomes the disadvantages and limitations of the prior art by providing a measurable interactive stimulus during programs and advertising that may be employed to establish and maintain viewer loyalty to programs and advertising. Viewers may be invited to participate in interactive content that may be provided as an enhancement to a program. The method of the present invention may also be implemented as part of an affinity marketing program that allows broadcasters to identify viewers interested in a certain product or topic, and to offer the viewer related products or information from multiple sellers.

Viewers may earn points by watching programming that may comprise program content and/or advertising and by responding to on-screen prompts or selected events within the program. Points may be accumulated and then redeemed for merchandise related to the program or network. Prompts synchronized with video programming may invite viewers to a program's interactive site where viewers may review account status, learn more about other programming offered by the network, set reminders for upcoming shows and perform other interactions.

The invention therefore may comprise a method of rewarding viewers to watch broadcast content comprising: informing the viewers that awards may be earned by responding to specific events contained in the broadcast content, identifying the specific events, providing an interface through which the viewers may enter a response to the events, receiving the response, assigning a point value to the response, accumulating the point value with previous point values, if any, associated with a previous response from the viewer to produce a point total, and providing redemption of the points when the point total is greater than or equal to a predetermined number of points.

Advertising content may also be enhanced in a similar manner, wherein points are awarded for responses to on-screen prompts or selected events, and may include “point sharing” such that points may be awarded to a viewer for responses associated with programs and advertising.

Viewer participation is simple and voluntary. The viewer may be invited to register through interactive on-screen prompts and/or through on-air promotions. Registration may also be accomplished through web site access employing the Internet. Registration may also include selection of a program or programs with which the viewer may interact and accumulate points. Once registered, stimulus may be provided whenever an associated program is displayed, or stimulus may be provided in response to selection of an on-screen icon, remote control function, or other user input. The viewer may earn points by responding to program icons and events through remote control key entry, mouse or pointing device entry, or other input device entry, such as a keyboard, for example. If a viewer has not participated in a program for a period of time, the stimulus for that program may be discontinued, allowing the viewer to either re-establish participation through web site access, or to discontinue participation without further action.

For example, viewers may earn points for finding and responding to various elements or events hidden within the program, such as certain characters, actors, or automobiles in a program, or when an event occurs, such as when certain phrase or key words are spoken. Additionally, points may be awarded to viewers who tune in for every episode of a given series. For example, viewers may be awarded 100 points for each individual episode, and a progressive 100 points if the episodes are viewed week-to-week. Further, viewers may earn additional points by remaining tuned during commercials and responding to either on-screen prompts or in-program campaigns coordinated with the program. An interactive site may be created and may be branded by a broadband network operator. This site may provide viewers a single location for registering with participating point programs as well as reviewing account status. A viewer may employ a television with set top box, computer, or other network capable device to access a web site and determine point totals, what points may be redeemed for, and to redeem points for merchandise, products, or services.

The invention may further comprise a system for rewarding a viewer to watch broadcast content comprising: a server that includes an enhancement that may be broadcast with the broadcast content, the enhancement indicating an event for which a viewer response can be awarded points, a network connection that communicates the response from the viewer, a first software program that receives the response and assigns a point value to the response, and a second software program that accumulates the point values with previous point values, if any, and stores an accumulated result.

Advantages of the present invention include providing accurate measurement of viewing, establishing viewer loyalty for viewing content including advertising, providing a measure of viewer interest in new content, and for collecting viewer information may be employed for market analysis and marketing strategies.

### DESCRIPTION OF THE FIGURES

In the figures,

FIG. 1 depicts a system environment of an embodiment of the present invention.

FIG. 2 depicts a viewer registration interface as may be presented through a web page or through a receiving unit.

FIG. 3 depicts software routines that may be stored in the viewer's receiving unit.

FIG. 4 depicts an electronic entry form that may be employed to establish a points reward campaign.

FIG. 5 depicts an enhancement creation screen.

FIG. 6 depicts a data encapsulation screen.

FIG. 7 is a flowchart of operation of an embodiment of the present invention.

### DETAILED DESCRIPTION OF THE INVENTION

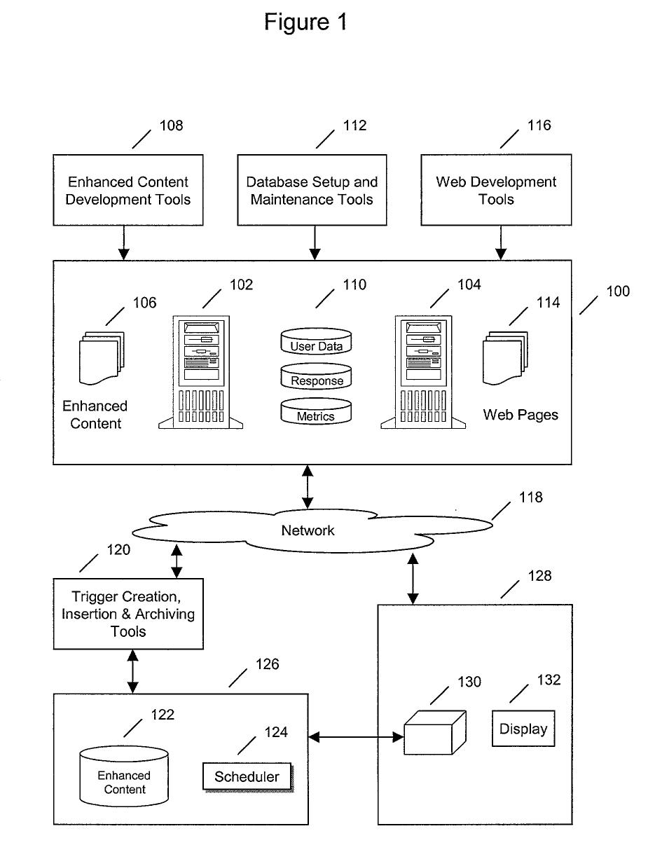

FIG. 1 depicts a system environment of the present invention. Server group 100 comprises servers 102, 104 that are typically independent units and may be at separate locations, however a single server may be employed. Server 102 may contain enhanced content 106 that may be created employing enhanced content development tools 108. Enhanced content development tools 108 may be employed to create receiving unit independent enhanced content code that is stored in the receiving unit that that receives viewer responses and sends them to a server. Development of enhancements may employ methods as disclosed in U.S. patent application Ser. No. 09/935,492 entitled “System and Method for Web Based Enhanced Interactive Television”, filed Aug. 23, 2001 by Steven O. Markel, which is herein specifically incorporated by reference for all that it discloses and teaches. Development of enhancements may also employ methods as disclosed in U.S. patent application Ser. No. 09/941,246 entitled “Method of Enhancing Streaming Media Content”, filed Aug. 27, 2001 by Steven O. Markel, which is herein specifically incorporated by reference for all that it discloses and teaches. Development and distribution of enhancements may also employ methods as disclosed in U.S. patent application Ser. No. 09/933,927 entitled “System and Method for Distribution of Interactive Content to Multiple Targeted Platforms”, filed Aug. 21, 2001 by Steven 0. Markel, which is herein specifically incorporated by reference for all that it discloses and teaches. Enhancements may employ a platform independent format as disclosed in U.S. patent application Ser. No. 10/007,437 entitled “Device Independent Video Enhancement Scripting Language”, filed Nov. 30, 2001 by Steven O. Markel et al., which is herein specifically incorporated by reference for all that it discloses and teaches. Further, a receiving unit, described later, may accept or solicit a set of enhancements that are compatible with the particular type of receiving unit, as is disclosed in U.S. patent application Ser. No. 09/934,354 entitled “Detection and Recognition of Data Receiver to Facilitate Proper Transmission of Enhanced Data”, filed Aug. 20, 2001 by Steven 0. Markel, which is herein specifically incorporated by reference for all that it discloses and teaches. Additionally, viewer response to on-screen indicators, described later, may employ methods disclosed in U.S. patent application Ser. No. 10/041,881 entitled “Creating On-Content Enhancements”, filed Oct. 24, 2001 by Gary Rasmussen et al., which is herein specifically incorporated by reference for all that it discloses and teaches.

Enhanced content may comprise images and or audio that may be displayed in a synchronized manner with a program or advertisement. Enhanced content may also comprise a software program downloaded to a viewers receiving unit that supports viewer response to program events. Server 104 may contain data items 110 that may be created using database setup and maintenance tools 112. Database setup and maintenance tools 112 may be employed with a database for capturing registration information, user response data, aggregation, point redemption, and report generation. Server 104 may also contain web pages 114 that may be created using web development tools 116. Web pages 114 may allow a viewer to register for a points program, see accumulated points, redeem points for products or services, and to access customer service functions. Web pages 114 may also be generated in one or more versions that are compatible with set top boxes, interactive televisions, or other equipment such as WebTV form WebTV Networks Inc. of Palo Alto, Calif.

Server group 100 is connected to network 118 that may comprise a LAN, WAN, Internet, or other network, including cable television and satellite television networks. Enhanced content may be transferred from server group 100 and may be processed by trigger creation, insertion, and archiving tools 120 to produce ready for broadcast enhanced content 122 that may be accessed by broadcast unit 126 and may be transmitted employing scheduler 124. The transmitted signal is received by receiving unit 130 at viewer premises 128 and is presented on display 132. Receiving unit 130 may comprise a television, interactive television, set top box, satellite receiver, computer, or other device operable to receive a broadcast and operable to receive viewer input and communicate the input to server group 100. Some or all of the elements shown in FIG. 1 may be employed to practice various embodiments of the present invention.

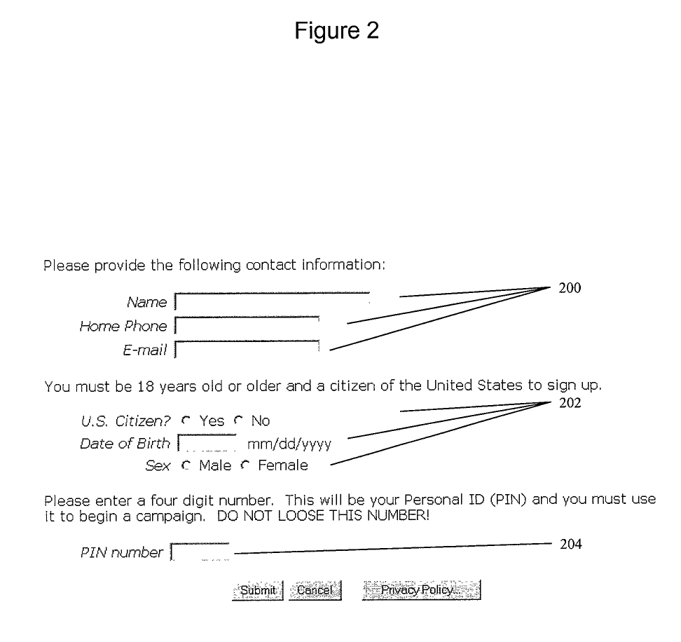

In each of the embodiments, a viewer typically registers to establish an account in which points may be accumulated. FIG. 2 depicts a viewer registration interface as may be presented through a web page or through a receiving unit. The registration interface may comprise contact information 200, demographic information 202, and security information 204. Contact information 200 may comprise the viewer's name, e-mail address, telephone, mailing address or other information. Demographic section 202 may comprise age, gender, and other information that may be used to determine characteristics of the viewing audience. Security information 204 may comprise a personal identification number (PIN) or other security information that may be employed to provide security when accessing point information or when redeeming points for products or services. Some information may be optional and some may be required. In some instances, registration may be automatic such that members of certain groups may be ‘pre-registered’ and need only enter a PIN to complete registration. When a viewer submits registration information, a ‘cookie’ comprising a small amount of information, that may include registration information and an account ID (identification), may be stored on the viewers receiving unit. A reply may be sent to the viewer to confirm registration and to verify the e-mail address provided. From the registration information, a viewer account may be established in server 104 shown in FIG. 1. The registration interface of FIG. 2 may also provide links to other pages that describe terms, conditions, policies, rules, eligibility, prizes and other information associated with the points award program.

In a first embodiment, after the viewer is registered, broadcast unit 126 transmits enhanced content 122 to a viewer's receiving unit 130 that includes visible or audible stimulus that is then presented on display 132. Enhanced content 122 may also comprise a program that is stored in receiving unit 130 that receives user input in response to the stimulus or to an identified event. The program may be employed to establish a period in time (a capture window) during which a viewer response may be accepted. If a viewer response is received outside the period of time, the response may be rejected. Further, if a number of responses in excess of a predetermined threshold are received, all responses may be rejected. Such rejection of responses may be employed to award points only to viewers that are actually watching a program or advertisement and respond within the appropriate period of time such that viewers that randomly respond or employ automated or programmatic methods to produce responses are not awarded points. Enhanced content 122 may include information determining the start and end of the capture window.

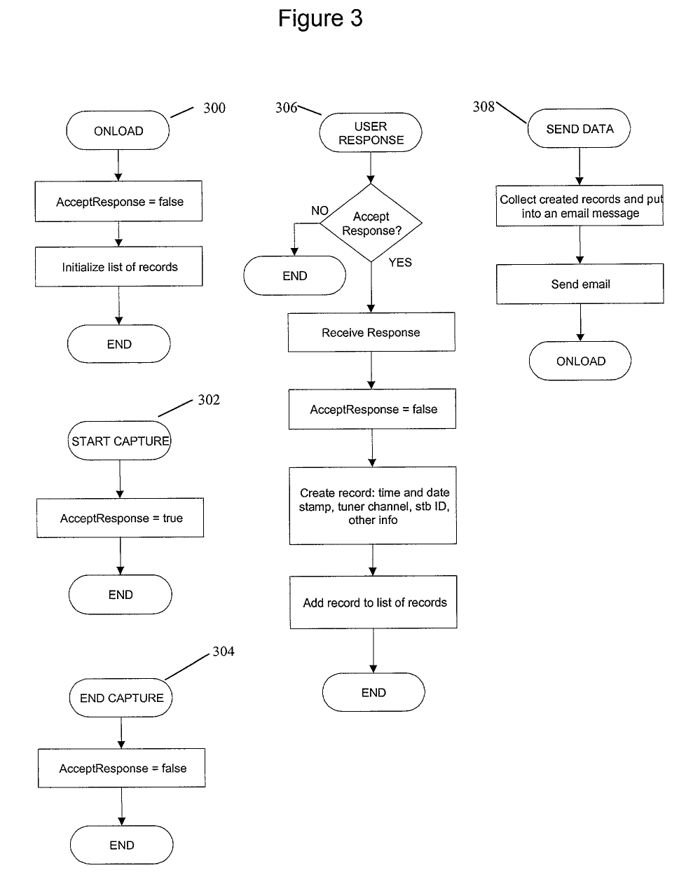

FIG. 3 depicts software routines that may be stored in the viewer's receiving unit. The software routines depicted in FIG. 3 may be invoked as a result of information received from broadcast unit 126 or from user input. The software routines shown in FIG. 3 may be downloaded to a receiving unit as part of the enhanced content or may be accessed through a network connection such as the Internet. When the code is initialized, onload routine 300 is invoked. Onload routine 300 may first set an “AcceptResponse” variable to false to ignore viewer input until program initialization is complete and an enabling signal is received. Onload routine 300 may then setup and initialize a list configured to hold a list of valid viewer responses. After the lists are configured and any other initialization tasks completed, onload routine 300 is completed. The start capture routine 302 may be invoked in response to information contained in enhanced content 122 that indicates the beginning of a capture window. Start capture routine 302 sets the “AcceptResponse” variable true, allowing viewer response inputs to be received. The end capture routine 304 may be invoked in response to information contained in enhanced content 122 that indicates the end of a capture window. End capture routine 304 resets the “AcceptResponse” variable such that no viewer responses are accepted. When a viewer response input is received, user response routine 306 checks the variable “AcceptResponse” to see if it is true. If “AcceptResponse” is not true, no viewer response inputs are accepted and the routine ends. If the “AcceptResponse” variable is true, then the routine waits until a viewer response is received or until the “AcceptResponse” variable is reset by end capture routine 304. If a viewer response is received, the “AcceptResponse” variable may be reset to false to reject further responses from being captured until the “AcceptResponse” variable is set true by the start capture routine 302. The received viewer response results in a record being created. The record may contain a time and date stamp, the channel the set top box is tuned to, the set top box ID (identification) code, and other relevant information. This record is then added to the list of any existing records that were previously created. The send data routine 308 may be invoked in response to information contained in enhanced content 122. Send data routine may create a message comprising information from the list of records and may send the message to a server, such as server 104 of FIG. 1. As previously described, the embodiment may also accept a plurality of responses and may accept or reject responses by employing an algorithm that determines if a program or advertisement is being watched.

In another embodiment, a program is downloaded to a receiving unit through a broadcast network, or other network such as the Internet, for example. Contained within the program is a description or indication of people, things, or events in a program or advertisement to which a viewer may respond and earn points. The indication may be in the form of buttons or icons that may be selected when a thing or event is seen in a program or advertisement. For example, a display may comprise buttons labeled with items such as an automobile brand, soft drink brand, or other merchandise brand and points may be awarded if the viewer selects the button when a corresponding image is displayed in a program or advertisement. The buttons may also be labeled to correspond to events such as kisses, winks, spoken words, or other events that may be employed to measure viewer attentiveness to a program or advertisement. Viewer responses may be sent to a server as they are received, may be stored and sent at predetermined intervals, when a predetermined number of responses have been accumulated, or may be sent in response to a signal from a server. This embodiment employs the registration and viewer information but does not require the development of enhancements. As previously described, this embodiment may accept a plurality of responses and may accept or reject responses by employing an algorithm that determines if a program or advertisement is being watched. The algorithm may be implemented in the receiving unit or in a server. This embodiment may be implemented in a computer, such as a laptop computer with wireless Internet connection, for example, such that the audio and video of programs and advertisements are not altered. In this manner the viewer may watch unaltered broadcast programs and advertisements and may earn points through responses input to the laptop computer that reflect people, things, or events contained within a broadcast program or advertisement.

In each of the aforedescribed embodiments, information of viewer response to program events, people, things, or other stimuli, is transferred to a server. The accumulated responses of a plurality of viewers may be employed to produce a report of viewing statistics including number of viewers, distribution of demographics of viewers, attentiveness to program and advertising content and other metrics that may be employed to assess audience characteristics and to select advertising tailored to a particular audience. Further, the number of points associated with a program may be increased in order to attract viewers. Bonus point events may be employed to attract viewers during periods of lower viewership. Bonus point events may also be configured to attract certain groups of viewers, such as those over 40 years of age, for example, to programs that include advertising directed to that group.

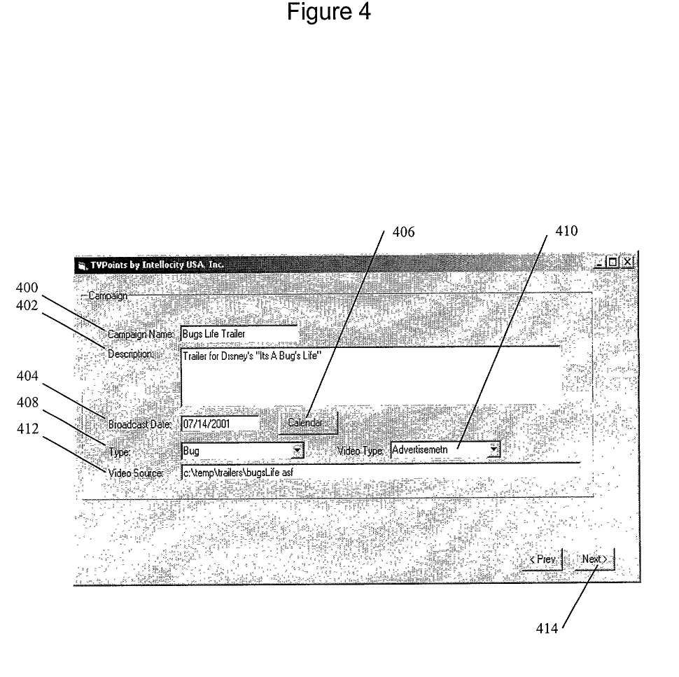

Implementation of the present invention may be simplified through the use of a campaign wizard through which programs, enhancements, stimuli, and point rewards may be defined. FIG. 4 depicts an electronic entry form that may be employed to establish a points reward campaign. Campaign name 400 is a label the user may assign to this particular campaign for easy retrieval or modification later. Description 402 is a textual description of the campaign that may be also be accessed as part of a search for a particular campaign or type of campaign. Broadcast date 404 and calendar 406 may be used to specify the expected broadcast date of the enhanced content. The campaign type 408 allows the user select the type of campaign. Campaign types may include:

“Watch” campaigns in which on-screen prompts are displayed at the beginning of a program

“Watch Closely” campaigns in which prompts, invisible to the viewer, are synchronized with certain events within a program (such as a keyword being spoken, for example)

“Watch Them All” campaigns in which multiple episodic Watch campaigns are linked and bonus points are awarded to viewers who participate in a predetermined number of episodes within a series.

“Watch Them All Closely” campaigns in which multiple Watch Closely campaigns, and/or individual events across multiple episodes, are linked and bonus points are awarded to viewers who participate in a predetermined number of episodes within a series.

“Watch and Win” campaigns in which viewers may find and collect “game pieces” embedded in a program or advertisement and then may access a related site to determine if their game piece is a winner.

“Live” campaigns in which on-screen and/or hidden prompts are made available to the viewer by the director of a live event

“Advertising” campaigns in which on-screen and/or hidden prompts are made available to the viewer during a commercial and responding to the prompt increments the viewer's account for the currently tuned service and/or MSO.

“Walled Garden” campaign in which visiting participating walled garden sites and/or clicking on interactive ads shall increment the viewer's designated account (MSO or Service Provider)

Continuing with FIG. 4, Video type 410 may be an advertisement, full-length feature video, and may be also indicated as the video source 412. Clicking on the ‘Next>’ button 414 may bring up an enhancement creation screen.

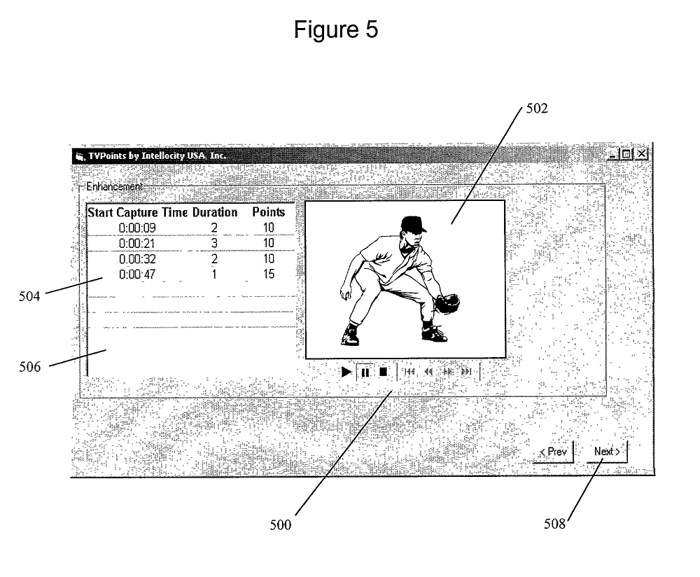

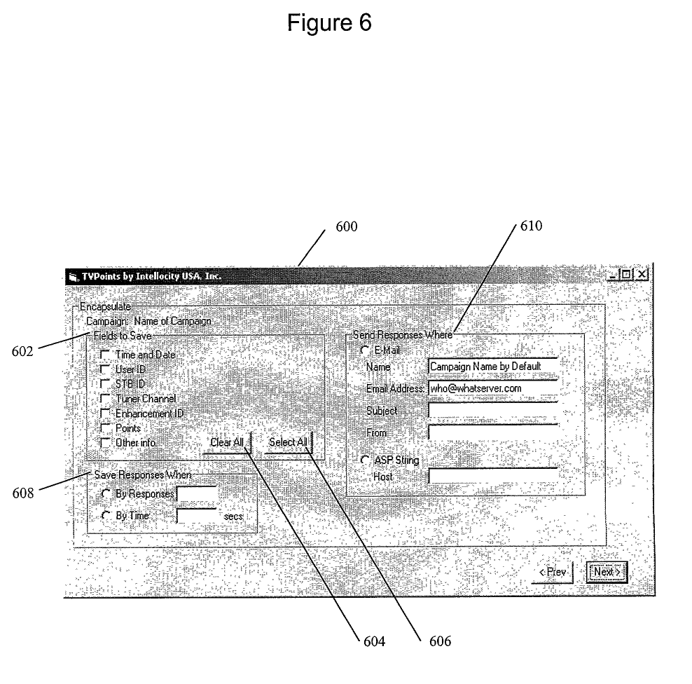

FIG. 5 depicts an enhancement creation screen. A user may employ video controls 500 to start, stop, pause, and reposition a video program or advertisement at any location. Images of the movie may be presented in image preview area 502. When paused, an event entry 504 comprising start capture time, duration of the capture event, and the number of points awarded may be entered into event list 506. The start capture time and duration of capture event may be employed by the start capture 302 and end capture 304 routines depicted in FIG. 3. When the enhancements have been entered, a user may select the Next> button 508 may navigate the user to a data encapsulation screen as shown in FIG. 6.

FIG. 6 depicts a data encapsulation screen. This screen may be employed to define data to be stored from viewer responses. Data storage may correspond to steps performed in user response routine 306 shown in FIG. 3 and the data may be stored in server 104 of FIG. 1. Employing data encapsulation screen of FIG. 6, the user may define how to encapsulate the data from viewer responses. Encapsulation screen 600 comprises data selection menu 602, data scheduling 608, and data destination 610. Through data selection menu 602, the user may select what data is to be transferred. Types of data may include time and date, user ID, tuner channel, enhancement ID, points and other information. Clear button 604 and select all button 606 may be employed to simplify data type selection. Data scheduling menu 608 may be employed to define when data is transferred. Data may be transferred when a predetermined number of responses have been stored, at predetermined intervals, or by event, such as the selection of another channel or turning off of the receiving unit, for example. The scheduling of data transfers may also reflect load balancing requirements of a server or other criteria. Data destination menu 610 may be employed to specify or select the server to which data is transferred and to specify an identifier or other information sent with the data.

The viewer may be notified by e-mail if accumulated points reach or exceed a predetermined count. If a viewer's point total is near value that allows redemption for a product or service, an e-mail message may be generated to encourage the viewer to watch a particular broadcast or broadcasts.

A viewer may obtain information regarding how to participate in a points program through a web site or though information displayed on the viewer's receiving unit. An operational sequence may comprise:

a viewer is watching a broadcast program.

the viewer is notified that the program is enhanced by having a “bug” popup on the screen. A bug is an icon or other visual indicator.

the viewer selects an enhanced mode by clicking a specific button on their remote control or keyboard. This selection of an enhanced mode may include transmission of a message from the receiving unit to a broadcast unit over an upstream channel or over a network such as the Internet.

the viewer may be greeted and provided with a page of “how to” instructions.

a trigger, embedded in the content, is sent to the receiving unit to enable acceptance of a viewer response.

software in the receiving unit may enable display of the specific “bug” or make the entire video screen a hotspot. The hotspot is enabled, effectively starting the capture of viewer responses.

when an event occurs, the viewer may provide a response through a mouse, remote control, keyboard, or other input device. The receiving unit detects the response and updates data containing a time & date stamp and other information, such as channel number, for example. Code may be included to produce a single entry if the user clicks multiple times within one event.

the receiving unit receives another trigger that disables the hotspot, effectively stopping the capture of responses. Alternately, a timer may be started at the receipt of the start capture trigger and after a predetermined amount of time, the hotspot is disabled.

a transmit signal may be created periodically, randomly, in response to size of data stored, or in response to another condition. When the transmit signal is activated, the receiving unit sends response information to a server

the server receives the information from receiving unit and may store the data or a portion thereof.

the server updates tables or other data structures.

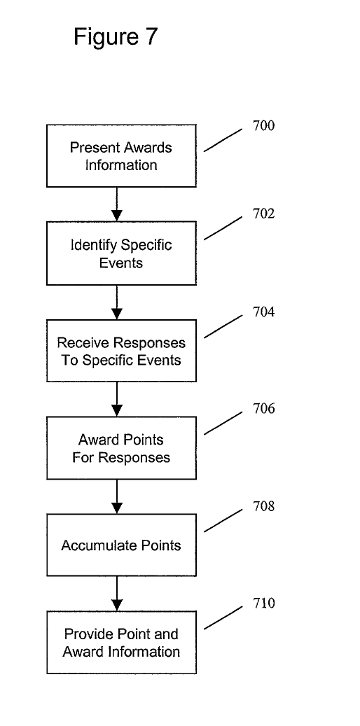

FIG. 7 is a flowchart of operation of an embodiment of the present invention. At step 700, information of the awards campaign is presented to viewers. Such presentation may comprise a promotional advertisement, e-mail, postal mail, web site or other conveyance of information. At step 702, events contained within broadcast content (i.e. a program or advertisement) are identified. Identification may comprise a list of visual or audible events, or may comprise a displayed image such as an icon or logo, for example, of items to watch or listen. At step 704, viewer responses to the events are received. At step 706, points are awarded for accepted viewer responses. At step 708, points are accumulated for each viewer. At step 710, information is provided describing products and service for which points may be redeemed.

A viewer may access a web page to determine the number of points accumulated, awards that may be provided, and other information. Access to awards may not require the entry of a password while access to accumulated points may require entry of a password. An operational sequence of viewer access to a website may comprise:

viewer accesses a points website.

viewer reviews available awards.

viewer accesses points account page.

viewer enters username and password

a server determines accumulated points.

a display may be produced and may contain text and graphics showing the number of points accumulated.

The present invention may also allow points to be earned by answering a questionnaire concerning a product or program, thereby allowing viewing of programs at a location other than the viewer's residence. A questionnaire may provide customer education of products and may be used to allow for vacations and viewing or programs with friends or relatives. A questionnaire may also offer a viewer an opportunity to accumulate additional points if the viewer's point total is near the number of points required to obtain an award. Additionally, audio signals may be used to indicate that reward points may be earned by user response. Audio signals may be employed to reduce viewer likelihood to mute audio output during advertising messages.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

I claim:

1. A method of rewarding viewers to watch broadcast content comprising:
informing said viewers that awards may be earned by responding to specific events contained in said broadcast content;
identifying said specific events;
providing an interface through which said viewers may enter a response to said events;
receiving said response;
assigning a point value to said response;
accumulating said point value with previous point values, if any, associated with a previous response from said viewer to produce a point total; and
providing redemption of said points when said point total is greater than or equal to a predetermined number of points.

2. The method of claim 1 wherein said step of receiving said response comprises:
creating a time period during which a viewer response may be received.

3. The method of claim 2 wherein said step of accumulating said point value further comprises:
not accumulating said count value if the number of viewer responses during said time period is greater than or equal to a predetermined number.

4. The method of claim 1 wherein said step of assigning a point value further comprises:
awarding additional points if said viewer has responded to a predetermined number of episodes of said content.

5. The method of claim 1 wherein said step of identifying said specific events further comprises:
outputting a visual indicator;

6. The method of claim 1 wherein said step of identifying said specific events further comprises:
outputting an audible indicator;

7. A system for rewarding a viewer to watch broadcast content comprising:
a server that includes an enhancement that may be provided with said broadcast content, said enhancement indicating an event for which a viewer response can be awarded points;
a network connection that communicates said response from said viewer;
a first software program that receives said response and assigns a point value to said response; and
a second software program that accumulates said point values with previous point values, if any, and stores an accumulated result.

8. The system of claim 7 further comprising:
a third software program that produces an interface through which said viewer registers to accumulate points.

9. The system of claim 7 further comprising:
a web page that describes a product that can be obtained by redeeming a predetermined number of points

10. The system of claim 7 further comprising:
a web page that describes a service that may be obtained by redeeming a predetermined number of points.

11. The system of claim 7 wherein said enhancement further comprises:
a signal that indicates the time period when a receiving unit will said response to said event from said viewer.

12. The system of claim 7 comprising:
a software routine that may be downloaded to a receiving unit, said software routine being responsive to a signal in said enhancement that indicates a time period when said receiving unit will accept said response to said event from said viewer.

13. A receiving unit for rewarding a viewer to watch broadcast content comprising:
a network connection that allows said receiving unit to communicate with a server, said server operable to receive a response to an event from said viewer, assign a point value to said response, and accumulate said point value with previous point values, if any, to produce a point total that may be redeemed for an award;
a first software program responsive to a signal contained in said broadcast, said signal indicating the beginning of a time period during which said response to an event may be received;
a second program that stores said response; and
a third program that transfers said response to said server.

14. The receiving unit of claim 13 wherein said receiving unit is a set-top box.

15. The receiving unit of claim 13 wherein said receiving unit is a personal computer.

16. The receiving unit of claim 13 wherein said receiving unit is an interactive television.

17. The receiving unit of claim 13 further comprising:
a software routine that accumulates a predetermined number of responses prior to transferring said responses to said server.

18. The receiving unit of claim 13 further comprising:
a software routine that transfers said response to said server at a predetermined time.

19. The receiving unit of claim 13 further comprising:
a software routine that transfers said response to said server when a transmit signal is present in said broadcast content.

20. A receiving unit for rewarding a viewer to watch broadcast content comprising:
a network connection that allows said receiving unit to communicate with a server, said server operable to receive a response to an event from said viewer, assign a point value to said response, and accumulate said point value with previous point values, if any, to produce a point total that may be redeemed for an award;
a first software program that displays a button containing an image representative of an event contained in said broadcast content;
a second program that receives an input from said viewer when said viewer activates said button, said second program associating said input with said button to produce response information; and
a third program that transfers said response information to said server.

21. The receiving unit of claim 20 wherein said response information further comprises:
the time that said input was received.

22. The receiving unit of claim 20 further comprising:
a software routine that inhibits transfer of said response information if a plurality of inputs greater than or equal to a predetermined number are received from said viewer.

23. The receiving unit of claim 20 wherein said receiving unit is a set-top box.

24. The receiving unit of claim 20 wherein said receiving unit is a personal computer.

25. The receiving unit of claim 20 wherein said receiving unit is an interactive television.

26. A method of rewarding viewers to watch broadcast content comprising:
rendering said broadcast content;
rendering a reward indicator in conjunction with said broadcast content;
receiving a viewer response to said indicator and producing a count;
accumulating said count with a previous count, if any, to produce a count total; and
providing a reward when said count total is greater than or equal to a predetermined value.

27. The method of claim 26 further comprising:
defining a time period during which said viewer response may be accepted.

28. The method of claim 26 wherein said step of receiving a viewer response further comprises:
not producing said count if the number of viewer responses for said reward indicator is greater than or equal to a predetermined number.

29. A system for rewarding a viewer to watch broadcast content comprising:
a server that receives a response from said viewer to an event contained in said broadcast content for which said viewer response can be awarded points, said response including information identifying said event and said viewer;
a network connection that communicates said response from said viewer;
a first software program that receives said response and assigns a point value to said response; and
a second software program that accumulates said point values with previous point values, if any, and stores an accumulated result.

30. The system of claim 29 further comprising:
a third software program that produces an interface through which said viewer registers to accumulate points.

31. The system of claim 29 further comprising:
a web page that describes a product that can be obtained by redeeming a predetermined number of points

32. The system of claim 29 further comprising:
a web page that describes a service that may be obtained by redeeming a predetermined number of points.

33. A system for implementing point rewards for viewer response to events associated with broadcast content comprising:
a campaign creation tool that specifies a campaign name, broadcast date, and video source of said broadcast content;
an event definition tool that specifies a time period associated with an event occurring in conjunction with said broadcast content during which a viewer response will be accepted, and that allows a point value to be assigned to said response; and
a data encapsulation tool that defines data to be saved, the scheduling of when said data is saved, and the location at which said data is saved.

34. A method of providing broadcast content viewing information comprising:
implementing a points award method wherein viewers are awarded points for responding to events associated with presentation of said broadcast content, said method including registering viewers and obtaining demographic information describing said viewers;
receiving responses from said viewers;
calculating the number of said viewers providing responses to said presentation of said broadcast content; and
generating a report including the number of said viewers and a demographic profile of said viewers.
